(19) United States
(12) Patent Application Publication
(10) Pub. No.: US 2023/0223870 A1
(43) Pub. Date: Jul. 13, 2023

(54) SELF-CHARGING MULTI-LAYER TRIBOELECTRIC PPE

(71) Applicant: E-MASK LLC, Spring, TX (US)

(72) Inventors: Barnali Ghatak, Kolkata (IN); Sanjoy Banerjee, Kolkata (IN); Sk Babar Ali, Kolkata (IN); Rajib Bandyopadhyay, Kolkata (IN); Nityananda Das, Kolkata (IN); Bipan Tudu, Kolkata (IN); Dipankar Mandal, Punjab (IN)

(73) Assignee: E-MASK LLC, Spring, TX (US)

(21) Appl. No.: 18/011,043

(22) PCT Filed: May 17, 2021
(86) PCT No.: PCT/US2021/032787

§ 371 Date: Dec. 16, 2022

(30) Foreign Application Priority Data
Jun. 18, 2020 (IN) 202031025622

(51) Int. Cl. H02N 1/04; A41D 13/11; B01D 39/18; B01D 39/16; A62B 23/02

(52) U.S. Cl. CPC H02N 1/04; A41D 13/1107; B01D 39/18; B01D 39/1623; A62B 23/025; B01D 2239/0435; B01D 2239/0442; B01D 2239/0471; B01D 2239/065

(57) ABSTRACT

A triboelectric personal protective equipment (PPE) includes a first layer of a first triboelectric material; a second layer of a second triboelectric material; a circuit configured to store and transfer triboelectric charge generated from the first layer and the second layer; a third layer and a fourth layer connected to and powered by the circuit. The first triboelectric material and a second triboelectric material have a difference in triboelectric charge density (TECD) of at least 35 μC/m². The third layer and the fourth layer provide an electric field that is configured to electrify particles having a size of 10 nm to 10 μm between the third layer and the fourth layer.

### CROSS-REFERENCE TO RELATED APPLICATIONS

This present application claims priority from Indian Patent Application No. 202031025622 filed Jun. 18, 2020, the content of which is incorporated herein in its entirety.

### BACKGROUND

In the global COVID-19 crisis, pathogens (e.g., virus) may spread between people in close contact through airborne transmission. When an infected person talks, coughs, or sneezes, aerosols (<5 μm) or droplets (>5 μm) particles may carry the pathogen particles along. Larger size particles may settle under gravitational force, but smaller particles can stay in the environment for minutes to hours. Wearing personal protective equipment (PPE) may decrease the possibility of airborne transmission to certain extent, however developing an efficient filter is highly demanding.

Electrostatic adsorption is an effective way to bind and cling charged particles to the fibers. For example, triboelectric effect is a type of contact electrification in which certain materials become electrically charged upon contact with another different material, and are then separated. Filtering technology based on triboelectric effect may restrict pathogens from spreading in the environment through electrostatic adsorption. Triboelectric series materials are capable of generating triboelectric charges from human activities including respiration, talking, any facial or lip movement, or more, therefore may be used in an efficient filter.

### BRIEF SUMMARY

Certain embodiments of the disclosure will be described with reference to the accompanying drawings, where like reference numerals denote like elements. It should be understood, however, that the accompanying figures illustrate the various implementations described and are not meant to limit the scope of various technologies described.

In one aspect, embodiments disclosed herein are directed to a triboelectric PPE including a first layer of a first triboelectric material; a second layer of a second triboelectric material; a circuit configured to store and transfer triboelectric charge generated from the first layer and the second layer; a third layer and a fourth layer connected to and powered by the circuit. The first triboelectric material and a second triboelectric material have a difference in triboelectric charge density (TECD) of at least 35 μC/m². At least one of the first and second layer is one or more of cellulose, polyvinyl chloride, polyester, polyimide, polyvinylidene fluoride, polyethylene, poly(ethylene terephthalate), poly(methyl methacrylate), Nylon, polypropylene, paper, cotton, silk, chiffon, wool, and polyurethane. The third layer and the fourth layer provide an electric field that is configured to electrify particles having a size of 10 nm to 10 μm between the third layer and the fourth layer.

In another aspect, embodiments disclosed herein are directed to method of filtering particles using a PPE, comprising: stacking a first layer of a first triboelectric material, a second layer of a second triboelectric material, a third layer. and a fourth layer; generating triboelectric charge at the first layer and the second layer; transferring the triboelectric charge to the third layer and the fourth layer through a circuit; and electrifying a particle between the third layer and the fourth layer.

Other aspects and advantages of this disclosure will be apparent from the following description made with reference to the accompanying drawings and the appended claims.

### BRIEF DESCRIPTION OF THE DRAWINGS

FIG. 1 is a triboelectric mask according to one or more embodiments of the present disclosure.

FIG. 2 is a triboelectric mask according to one or more embodiments of the present disclosure.

FIG. 3 is a triboelectric mask according to one or more embodiments of the present disclosure.

FIG. 4 is output currents and output powers of a triboelectric mask according to one or more embodiments of the present disclosure.

FIG. 5 is output currents and output powers of a triboelectric mask according to one or more embodiments of the present disclosure.

### DETAILED DESCRIPTION

Triboelectric series materials (TSMs) harvests energy harvesting and converts the external mechanical energy into electricity by a conjunction of triboelectric effect and electrostatic induction. The triboelectric effect (i.e., triboelectric charging) is a type of contact electrification on which certain materials become electrically charged after they are separated from a different material with which they were in contact. A potential is created by the triboelectric effect due to the charge transfer between two layers that exhibit opposite tribo-polarity. The TSMs may be applied to harvest all kind mechanical energy that is available, including human motion, vibration, mechanical triggering, wind, flowing water, and more. Vocal energy from talking. respiration (i.e., inhaling and exhaling), facial or lip movements may be used favorably in mask designs (and movement generally may be used in other personal protective equipment), resulting in contact/separation or friction between different materials, thus generating triboelectric charges and building up a potential between different materials.

One or more embodiments of the present disclosure relate to triboelectric personal protective equipment (PPE) including but not limited to a mask with multilayers that harvests energy from the activities and movements associated with the wearer. The triboelectric mask includes a triboelectric portion having two layers of TSMs and an electrocution portion. The conjugated effect of triboelectric charging and electrostatic induction enables effective inactivation of virus-containing aerosols or droplets in a bidirectional way. The triboelectric mask is cost-effective and user friendly, with nearly 100% filtration efficiency towards pathogens.

In one or more embodiments, the triboelectric PPE (such as mask) includes a triboelectric portion. which contains two layers of TSMs with different triboelectric charge densities (TECDs). The process of triboelectric charging results in one material gaining electrons on its surface (i.e., tribo-negative) and the other material losing electrons from its surface (i.e., tribo-positive), thus generating a potential between the two layers of TSMs. The relative positions of the two materials on the triboelectric series define which material gains electrons and which material loses electrons. The polarity and strength of the triboelectric charge depends on the selection of TSM materials, surface roughness, temperature, strain, and other properties. The TSM materials of interest are selected based on their triboelectric charge densities (TECDs). A material with a lower TECD value may lose electrons to another material with a higher TECD value and becomes positively charged. The charge becomes greater when the two materials have a larger difference in their TECD values. In one or more embodiments, the triboelectric portion comprises two TSM layers, where the two TSMs have a difference in TECD values of at least 35 μC/m². In some embodiments, the difference of TECD values between two TSMs may be more than 50 μC/m², or more than 80 μC/m², or more than 100 μC/m², or more than 150 μC/m², or more than 200 μC/m².

In one or more embodiments. TSMs used in the triboelectric PPE may comprise cellulose. polyvinyl chloride (PVC), polyester, polyamide. polyimide, polyvinylidene fluoride (PVDF), polyethylene (PE), poly(ethylene terephthalate) (PET), poly(methyl methacrylate) (PMMA), Nylon, polypropylene (PP), paper, cotton, silk, chiffon. wool, polyurethane (PU), or combinations thereof. In one or more embodiments, the two TSM layers may be paired as cotton-PP, Nylon-polyester, cotton-polyester. PMMA-PVDF. Nylon-PVDF, PP-polyester, PVC-Nylon, PP-PU, or any combination of TSMs with a difference of TECD values larger than 35 μC/m²

In one or more embodiments, a conductive material may be used to coat at least one TSM layer to increase conductivity. The conductive material may be graphite, or metal (e.g., silver or copper) based paint, or any other conductive paint with good adhesive properties to the TSM layer.

One or more embodiments of the present disclosure relate to a triboelectric PPE (such as a mask) including an electrocution portion, which comprises two layers of mesh and a spacer in between. The mesh may be steel, or any other metallic material that is conductive. The spacer may be polypropylene, polyester, polycarbonate, polystyrene, polytetrafluoroethylene (PTFE), polyethylene naphthalate (PEN), polyphenylene sulphide (PPS), polyimide, paper, or any insulating or dielectric material, with a thickness of no more than 5 μm. In some embodiments, the thickness of the spacer may be less. The electrocution portion is connected to the triboelectric portion through a voltage tripler circuit. When no aerosols or droplets are present, the induced charges generated from the triboelectric portion may be transferred to a storing capacitor and charges the electrocution portion. When aerosols or droplets are presented between the mesh layers of the electrocution portion, due to the low resistance (e.g., smaller than 1 kΩ) of the aerosols or droplets, the electric field of the mesh layers may electrify the aerosols or droplets and deactivate the pathogens. If the aerosols or droplets are large enough to create a short-circuit between the mesh layers of the electrocution portion, the short-circuit instantly release a current that is sufficient to evaporate the water in the aerosols or droplets and deactivate the pathogens. The triboelectric mask may effectively electrify particles with a wide range of sizes, from nanometers to microns. In embodiment directed to a mask, the mask may function a bidirectional way, such that when the wearer breathes in and out, the mask can both filter and inactivate virus containing aerosols during both breathing states.

In one or more embodiments, the electrical field induced in the layers of mesh may produce heat and evaporate the aerosols or droplets. The produced heat may be in the order of fJ/μm³/K and the temperature change of the PPE is in negligible amount, which would not affect triboelectric charge transfer or intensity of the electric field, or cause safety or breathing problems.

One or more embodiments of the present disclosure relate to a triboelectric PPE (such as a mask) that is self-powered (i.e., no external power is presented for activation or upon wearing). The contact/separation or the friction between two layers of TSMs caused by human activities may generate sufficient induced charge in a short period of time. The activation time needed to accumulate sufficient induced charge and build up enough potential may be less than about 15 minutes. In some embodiments, the triboelectric mask may be charged by an external power prior to wearing, reducing the activation time to less than less than about 2 minutes. The activation time may be reduced to about one minute, or about 20 seconds, or less, based on the selection of capacitor and external power. The external power may have an output power of about 3 W, such as 6V voltage and 500 mA current, to obtain an activation time of about 20 seconds. The external power may be connected to the two layers of TSMs in the triboelectric portion, instantly providing an initial potential.

In one or more embodiments, the triboelectric PPE includes at least one layer of fabric as outer protection. In one or more embodiments, the triboelectric mask includes at least one layer of fabric as inner protection. In one or more embodiments, the triboelectric portion is disposed in the middle of the triboelectric mask to cover the mouth and nose of the wearer. In one or more embodiments, the triboelectric portion is disposed to cover the whole mask. In one or more embodiments, the electrocution portion is disposed near the middle of the triboelectric mask to cover the mouth and nose of the wearer. In one or more embodiments, the electrocution portion is disposed to cover the whole mask. The triboelectric mask may be fabricated by stacking one or more layers described in one or more embodiments of the present disclosure.

In one or more embodiments, the thickness of each layer may vary based on the selection of materials, and may be in a range of about 0.001 mm to about dozens of mm. For example, Table 1 below lists possible thicknesses for different layer materials.

TABLE 1

| Material | Thickness (mm) |
|---|---|
| Cellulose (fiber) | 0.001-0.005 |
| PVC | 0.190-0.305 |
| Polyester | 0.40-1.00 |
| Polyamide | 0.025-0.25 |
| PVDF (membrane) | 0.20-0.45 |
| Polyethylene | 0.26-1.00 |
| PET | 0.05-0.35 |
| PMMA | 0.08-3.00 |
| Nylon | 0.50-100 |
| Polypropylene | 2.00-50.00 |
| Paper | 0.09-0.38 |
| Cotton | 0.15-0.38 |
| Silk | 12.00-40.00 |
| Chiffon | 6 |
| Wool | 25.40-381.00 |
| Polyurethane | 0.81-1.47 |

The thickness of each layer is selected such that the triboelectric PPE is light in weight and flexible to ensure comfortability of the wearer. The two layers of TSMs are in closed contact, regardless of thickness, to ensure triboelectric charge generation through contact/separation or friction upon inhalation or exhalation, facial movement, or lip movement of the wearer.

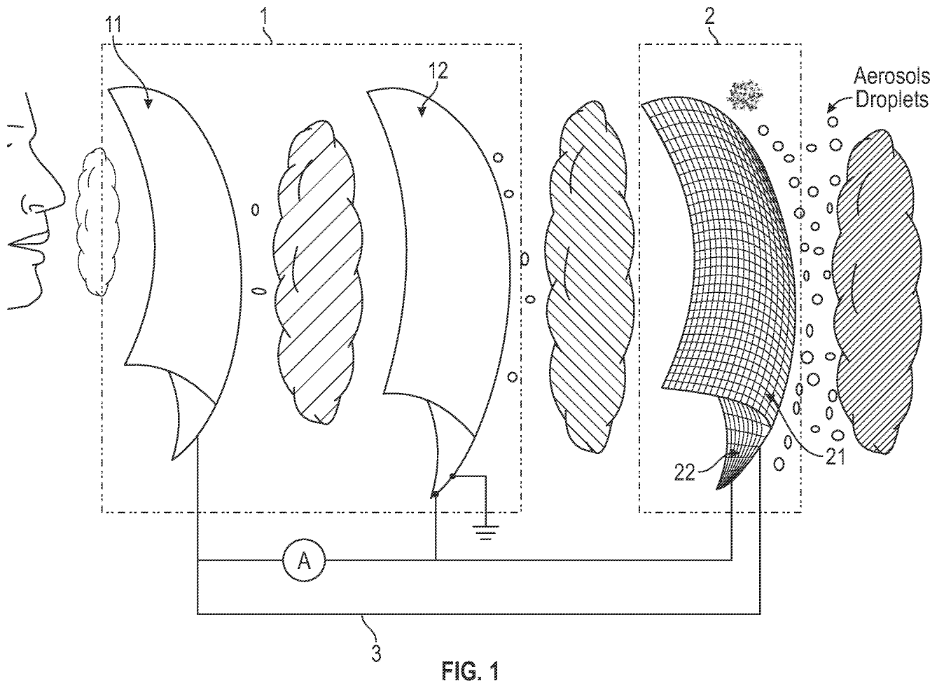

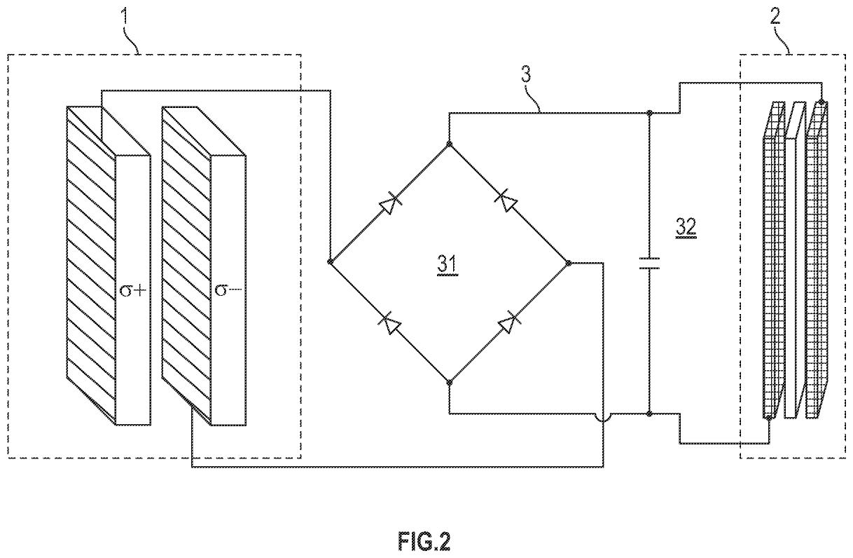

FIG. 1 shows a triboelectric mask according to one or more embodiments of the present disclosure. The triboelectric mask includes a triboelectric portion 1 and an electrocution portion 2, connected through a circuit 3. The triboelectric portion comprises two layers of TSMs 11 and 12, selected based on their TECD values. The electrocution portion 2 comprises two layers of mesh 21 and 22, separated by a spacer. The circuit 3 may include a voltage tripler circuit 31 and a capacitor 32, as shown in FIG. 2. Triboelectric charge is generated at the triboelectric portion, accumulated and stored in the circuit and transferred to the electrocution portion, when no aerosols or droplets are presented. When aerosols or droplets containing pathogens are presented to the electrocution portion, the aerosols or droplets having low resistance are electrified between the layers of mesh. Alternatively, the accumulated charges are instantly released, creating a short-circuit to deactivate the pathogen particles.

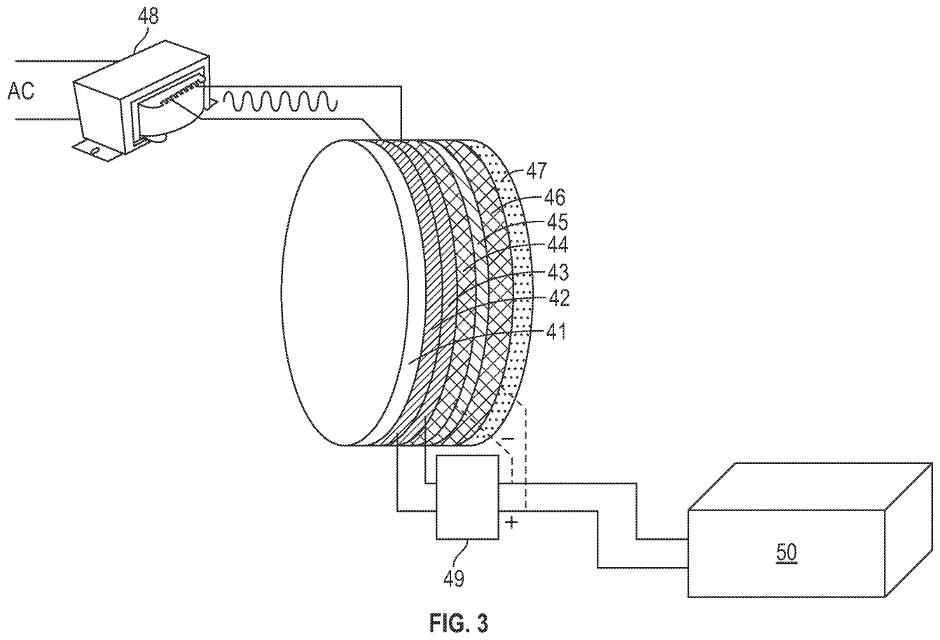

Another embodiment of a triboelectric PPE is shown in FIG. 3. The triboelectric mask comprises, from inner to outer, a layer of light cotton 41 as protection, a layer of cotton 42 which is tribo-positive, a layer of polypropylene 43 which is tribo-negative, two layers of steel 44 and 46 with a layer of polypropylene 45 as a spacer, and a layer of Nylon 47 as outer protection. The layers of cotton and polypropylene serve as the triboelectric portion, and are both coated with graphite to increase conductivity. The two steel layers with polypropylene spacer serve as the electrocution portion and is connected to the cotton and polypropylene layers through a voltage tripler rectifier circuit 49. The triboelectric charges generated from the cotton and polypropylene layers may be stored in the voltage tripler circuit, and transferred to the two layers of steel. The triboelectric mask may be self-powered or optionally activated by an external power (e.g., a transformer 48 providing 6 V and 500 mA power). Under an initial charging process using the external power, the activation time may be no more than 20 seconds. In some embodiments, a cathode-ray oscilloscope (CRO) may be used to obtain time and amplitude information of voltage signals.

### EXAMPLES

The following examples are merely illustrative and should not be interpreted as limiting the scope of the present disclosure.

### Example 1

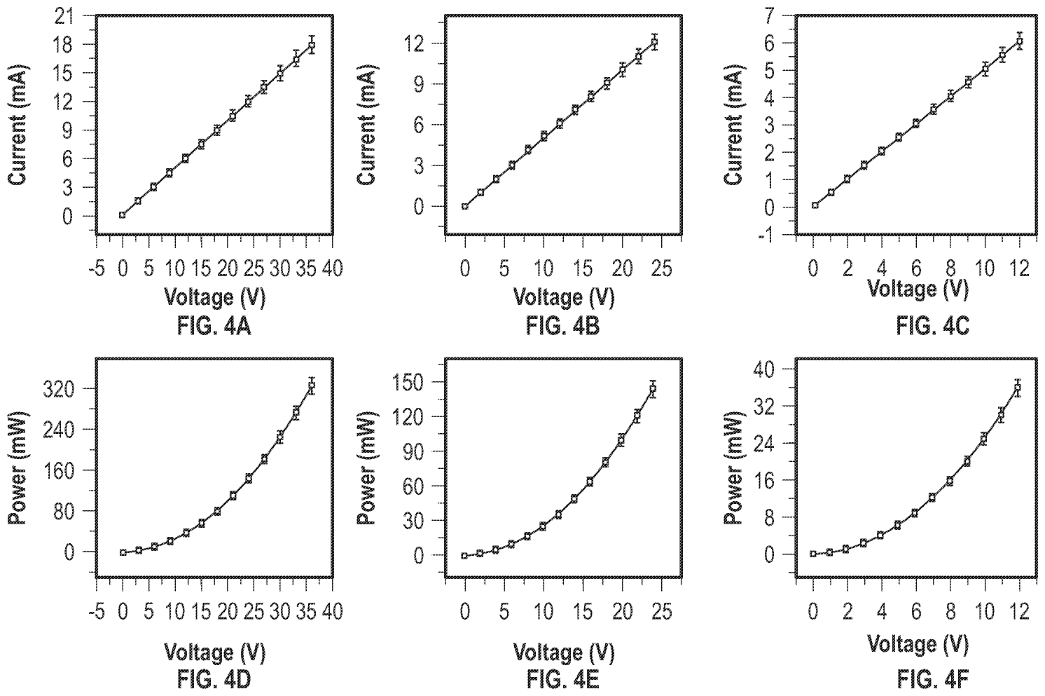

An example of a triboelectric mask may comprise Nylon and PVC as the two layers of TSMs. Nylon has a TECD value of about −18.35 μC/m² and PVC has a TECD value of about −117.53 μC/m². The large difference between their TECD values ensures efficient triboelectric charging. FIGS. 4a-4c and FIGS. 4d-4f show output currents and output powers in the electrocution portion at different percentages of the TECD differences, respectively. FIGS. 4a and 4d, 4b and 4e, 4c and 4f corresponds to 75%, 50%. and 25% of the TECD differences, respectively.

### Example 2

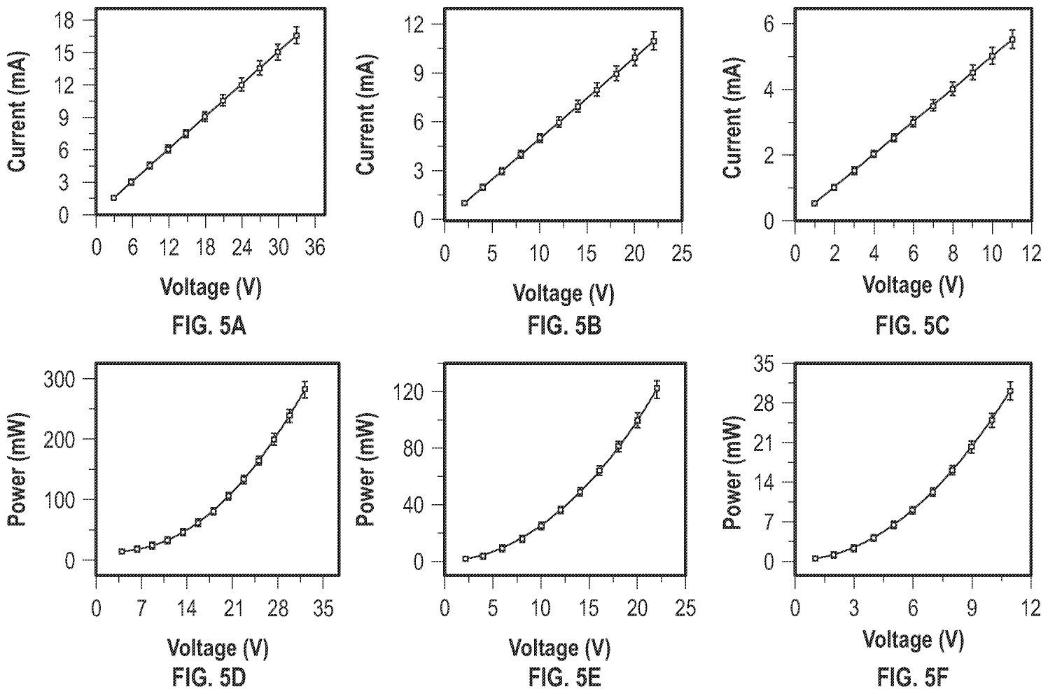

Another example of a triboelectric mask may comprise polypropylene (PP) and polyurethane (PU) as the two layers of TSMs. PP has a TECD value of about −27.23 μC/m² and PU has a TECD value of about −109.22 μC/m². The large difference between their TECD values ensures efficient triboelectric charging. FIGS. 5a-5c and FIGS. 5d-5f show output currents and output powers in the electrocution portion at different percentages of the TECD differences, respectively. FIGS. 5a and 5d, 5b and 5e, 5c and 5f corresponds to 75%, 50%, and 25% of the TECD differences, respectively.

While only a limited number of embodiments have been described, those skilled in the art having benefit of this disclosure will appreciate that other embodiments can be devised which do not depart from the scope of the disclosure.

Although the preceding description has been described here with reference to particular means, materials and embodiments, it is not intended to be limited to the particulars disclosed here; rather, it extends to all functionally equivalent structures, methods and uses, such as those within the scope of the appended claims.

The presently disclosed methods and compositions may suitably comprise, consist or consist essentially of the elements disclosed and may be practiced in the absence of an element not disclosed. For example, those skilled in the art can recognize that certain steps can be combined into a single step.

Unless defined otherwise, all technical and scientific terms used have the same meaning as commonly understood by one of ordinary skill in the art to which these systems, apparatuses. methods, processes and compositions belong.

The ranges of this disclosure may be expressed in the disclosure as from about one particular value, to about another particular value, or both. When such a range is expressed. it is to be understood that another embodiment is from the one particular value, to the other particular value. or both, along with all combinations within this range.

The singular forms “a.” “an,” and “the” include plural referents, unless the context clearly dictates otherwise.

As used here and in the appended claims, the words “comprise,” “has,” and “include” and all grammatical variations thereof are each intended to have an open, non-limiting meaning that does not exclude additional elements or steps.

“Optionally” or “optional” mean that the subsequently described event or circumstances may or may not occur. The description includes instances where the event or circumstance occurs and instances where it does not occur.

When the word “approximately” or “about” are used, this term may mean that there can be a variance in value of up to ±10%, of up to 5%, of up to 2%, of up to 1%, of up to 0.5%, of up to 0.1%, or up to 0.01%.

Ranges may be expressed as from about one particular value to about another particular value, inclusive. When such a range is expressed, it is to be understood that another embodiment is from the one particular value to the other particular value, along with all particular values and combinations thereof within the range.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, any means-plus-function clauses are intended to cover the structures described herein as performing the recited function(s) and equivalents of those structures. Similarly, any step-plus-function clauses in the claims are intended to cover the acts described here as performing the recited function(s) and equivalents of those acts. It is the express intention of the applicant not to invoke 35 U.S.C. § 112(f) for any limitations of any of the claims herein, except for those in which the claim expressly uses the words “means for” or “step for” together with an associated function.

1. A personal protective equipment (PPE) comprising:
a first layer of a first triboelectric material;
a second layer of a second triboelectric material;
a circuit configured to store and transfer triboelectric charge generated from the first layer and the second layer; and
a third layer and a fourth layer connected to and powered by the circuit.

2. The PPE of claim 1, wherein the first triboelectric material and the second triboelectric material have a difference in triboelectric charge density (TECD) of at least 35 μC/m².

3. The PPE of claim 1, wherein at least one of the first layer and the second layer is one or more of cellulose, polyvinyl chloride, polyester, polyimide, polyvinylidene fluoride, polyethylene, poly(ethylene terephthalate), poly(methyl methacrylate), Nylon, polypropylene, paper, cotton, silk, chiffon, wool, and polyurethane.

4. The PPE of claim 1, wherein the first layer is cotton and the second layer is polypropylene.

5. The PPE of claim 1, wherein the first layer is nylon and the second layer is polyvinyl chloride.

6. The PPE of claim 1, wherein the first layer is polypropylene and the second layer is polyurethane.

7. The PPE of claim 1, wherein the first layer and the second layer have a conductive coating thereon.

8. The PPE of claim 1, wherein the third layer and a fourth layer are conductive.

9. The PPE of claim 1, further comprises a spacer between the third layer and the fourth layer, with a thickness of no more than 5 μm.

10. The PPE of claim 1, further comprising an outmost layer of fabric, or an innermost layer of fabric, or both.

11. The PPE of claim 1, wherein the third layer and the fourth layer provide an electric field that is configured to electrify particles having a size of 10 nm to 10 μm between the third layer and the fourth layer.

12. The PPE of claim 1, wherein the first layer and the second layer are charged by an external power prior to use.

13. A method of filtering particles for personal protective equipment (PPE), comprising:
providing a multi-layer construction of a first layer of a first triboelectric material, a second layer of a second triboelectric material, a third layer, and a fourth layer;
generating triboelectric charge at the first layer and the second layer; and
transferring the triboelectric charge to the third layer and the fourth layer through a circuit.

14. The method of claim 13, wherein the first triboelectric material and the second triboelectric material have a difference in triboelectric charge density (TECD) of at least 35 μC/m².

15. The method of claim 13, wherein at least one of the first laver and tag second layer is one or more of cellulose, polyvinyl chloride, polyester, polyimide, polyvinylidene fluoride, polyethylene, poly(ethylene terephthalate), poly(methyl methacrylate), Nylon, polypropylene, paper, cotton, silk, chiffon, wool, and polyurethane.

16.-20. (canceled)

21. The method of claim 13, wherein a spacer is disposed between the third layer and the fourth layer, with a thickness of no more than 5 μm.

22. The method of claim 13, wherein the PPE further comprises an outmost layer of fabric, or an innermost layer of fabric, or both.

23. The method of claim 13, wherein the particles have a size of 10 nm to 10 μm.

24. The method of claim 13, further comprising charging the first layer and the second layer using an external power prior to use.

25. The method of claim 13, further comprising electrifying the particles between the third layer and the fourth layer.
